(19) United States
(12) Patent Application Publication
(10) Pub. No.: US 2026/0091825 A1
(43) Pub. Date: Apr. 2, 2026

(54) VEHICLE BODY STRUCTURE

(71) Applicant: NISSAN NORTH AMERICA, INC., Franklin, TN (US)

(72) Inventors: Luke CORDES, Bloomfiled Hills, MI (US); Ronald MORROW, Novi, MI (US); Srikanth Reddy BADDAM, Northville, MI (US); David KOVIE, Livonia, MI (US)

(21) Appl. No.: 18/902,783

(22) Filed: Sep. 30, 2024

(51) Int. Cl. B62D 25/06; B60R 22/24; B60R 22/34; E05F 15/611

(52) U.S. Cl. CPC B62D 25/06; B60R 22/24; B60R 22/34; E05F 15/611; E05Y 2900/546

(57) ABSTRACT

A vehicle body structure includes a roof structure and an accessory panel. The vehicle roof structure includes a rear roof bow (rear beam) adjacent to a rear hatch door opening. The rear roof bow has a concaved area with a first hinge portion located adjacent to the concaved area. The accessory panel has a second hinge portion that couples to the first hinge portion such that the accessory panel is pivotal between an open position and a stowed position. In the open position the concaved area is exposed and in the closed position the concaved area is at least partially concealed.

### BACKGROUND

### Technical Field

The present disclosure generally relates to a vehicle body structure. More specifically, the present disclosure relates to a vehicle body structure that include a rear beam having a concaved area dimensioned to receive at least one accessory device and a removable accessory panel that at least partially covers and conceals the at least one accessory device.

### Background Information

Vehicles such as sports utility vehicles (SUVs) and large passenger vehicles typically include a various accessories that are difficult to conceal and protect as interior body space becomes more and more limited in modern vehicles.

### SUMMARY

One object is to provide a rear beam of a vehicle body structure that includes a concaved area dimensioned to receive at least one accessory, such as a motor and/or a seatbelt device and an accessory panel that can move between a closed position at least partially concealing the at least one accessory and an open position exposing the at least one accessory.

In view of the state of the known technology, one aspect of the present disclosure is to provide a vehicle body structure with a roof structure, and an accessory panel. The vehicle roof structure includes a rear roof bow (rear beam) adjacent to a rear hatch door opening. The rear roof bow has a concaved area with a first hinge portion located adjacent to the concaved area. The accessory panel has a second hinge portion that couples to the first hinge portion such that the accessory panel is pivotal between an open position and a stowed position. In the open position the concaved area is exposed and in the closed position the concaved area is at least partially concealed.

### BRIEF DESCRIPTION OF THE DRAWINGS

Referring now to the attached drawings which form a part of this original disclosure:

FIG. 1 is rear perspective view of a vehicle body structure in accordance with an exemplary embodiment;

FIG. 2 a partially exploded rear perspective view of the vehicle body structure showing elements of a roof assembly, including a plurality of roof bows and a rear beam (a rear roof bow) in accordance with the exemplary embodiment;

FIG. 3 front view of rear beam (rear roof bow) removed from the vehicle body structure showing hinge structure that pivotally support a removable accessory panel in accordance with the exemplary embodiment;

FIG. 4 is a front perspective view of the rear beam showing the removable accessory panel in accordance with the exemplary embodiment;

FIG. 5 is a rear perspective cross-sectional view of the rear beam taken along the line 5-5 in FIG. 3 in accordance with the exemplary embodiment;

FIG. 6 is a front perspective view of the rear beam similar to FIG. 4 with the removable accessory panel removed revealing a concaved area of the rear beam in accordance with the exemplary embodiment;

FIG. 7 is a rear view of the rear beam removed from the vehicle body structure in accordance with the exemplary embodiment;

FIG. 8 is a front view of the rear beam removed from the vehicle body structure in accordance with the exemplary embodiment;

FIG. 9 is a side end view of the rear beam removed from the vehicle body structure in accordance with the exemplary embodiment;

FIG. 10 is a bottom view (looking upward) of the rear beam with the removable accessory panel removed in accordance with the exemplary embodiment;

FIG. 11 is a perspective cross-sectional view of the rear beam taken along the line 11-11 in FIG. 4 showing details of hinge portions that pivotally attach the removable accessory panel to the rear beam in accordance with the exemplary embodiment;

FIG. 12 is a bottom view (looking upward) of a main panel of the rear beam with other panels of the rear beam removed in accordance with the exemplary embodiment;

FIG. 13 is a perspective view of a rear assembly and portions of a side assembly of the vehicle body assembly partially assembled showing an inner side panel attached to a rear pillar and the main panel of the rear beam in accordance with the exemplary embodiment;

FIG. 14 is another perspective view of the rear assembly and portions of a side assembly of the vehicle body assembly partially assembled showing an upper panel of the rear beam attached to the main panel of the rear beam in accordance with the exemplary embodiment;

FIG. 15 is a yet another perspective view of the rear assembly and portions of the side assembly of the vehicle body assembly partially assembled showing a roof panel attached to the rear beam and an upper side rail section of the side frame assembly in accordance with the exemplary embodiment;

FIG. 16 is a yet another perspective view of the rear assembly and portions of the side assembly of the vehicle body assembly partially assembled showing an outer side panel attached to the inner side panel of the rear beam and a rear pillar of the rear assembly in accordance with the exemplary embodiment;

FIG. 17 is a rear exploded perspective view of the vehicle body structure showing a jig used to align the rear beam, the rear pillars and a bottom panel during assembly of the rear assembly of the vehicle body structure in accordance with the exemplary embodiment;

FIG. 18 is another rear exploded perspective view of the vehicle body structure showing the jig aligning the rear beam, the rear pillars and the bottom panel in accordance with the exemplary embodiment;

FIG. 19 is a rear perspective view of a portion of the main panel, a portion of one of the rear pillars, the inner side panel and the removable accessory panel showing a seat belt retracting mechanism and a motor that powers a rear hatch door (not shown) that are at least partially concealed within the concaved area of the rear beam with the removable accessory panel installed to the rear beam in accordance with the exemplary embodiment;

FIG. 20 is a bottom view (looking upward) of the rear beam showing the seat belt retracting mechanism and the motor attached to the rear beam within the concaved area of the rear beam at least partially concealed by the removable accessory panel in accordance with the exemplary embodiment;

FIG. 21 is a bottom perspective view (looking upward) of the rear beam showing the seat belt retracting mechanism and the motor attached to the rear beam within the concaved area of the rear beam at least partially concealed by the removable accessory panel in accordance with the exemplary embodiment;

FIG. 22 a rear view looking through a rear hatch opening of the vehicle body structure showing the removable accessory panel pivoted downward in accordance with the exemplary embodiment;

FIG. 23 is a bottom perspective view (looking upward) of the rear beam showing the removable accessory panel covering the concaved area in accordance with the exemplary embodiment;

FIG. 24 is a perspective view of a forward flange of a main panel of the rear beam showing slots that define a hinge area that allows pivotal movement of the removable accessory panel in accordance with the exemplary embodiment; and

FIG. 25 is another perspective view of the forward flange of the main panel of the rear beam showing the slots shown in FIG. 24 with hinge extensions extending through the slots define a hinge area of the removable accessory panel in accordance with the exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

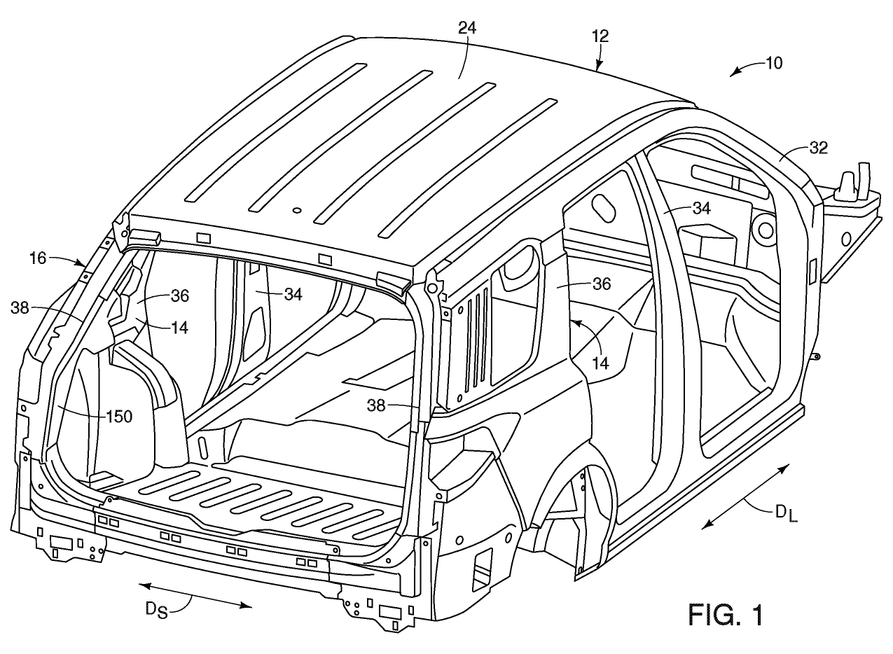

Referring initially to FIG. 1, a vehicle body structure 10 is illustrated in accordance with a first embodiment. The vehicle body structure 10 includes many elements and frame portions that are fixed to one another to form a rigid structure. For example, the vehicle body structure includes a roof frame assembly 12 (hereinafter referred to as the roof assembly 12), side frame assemblies 14 (hereinafter side assemblies 14) and a rear frame assembly 16 (hereinafter referred to as the rear assembly 16).

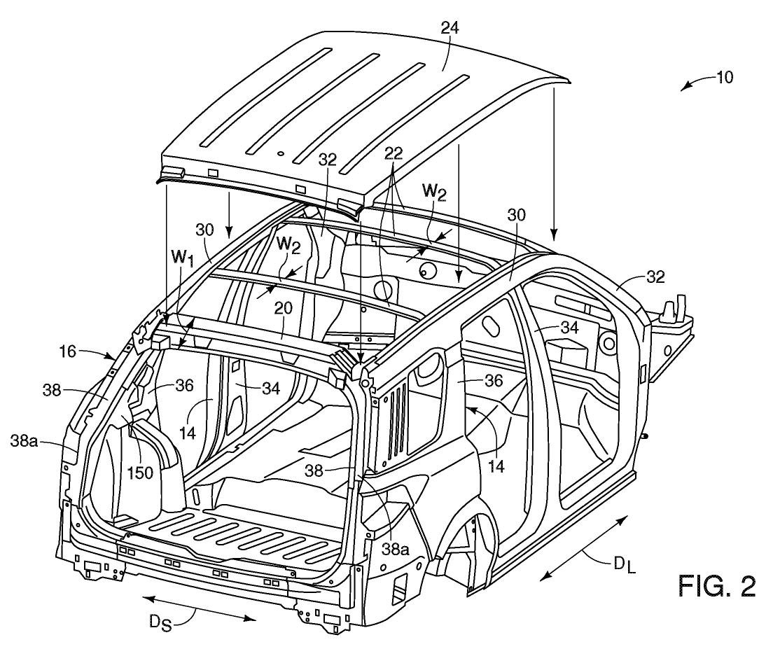

As shown in FIG. 2, the roof assembly 12 includes a rear beam 20, a plurality of roof bows 22 and a roof panel 24. The rear beam 20 is described below in greater detail. Each of the plurality of roof bows 22 extends in a vehicle lateral direction D_{S} (side to side direction) perpendicular to a vehicle lengthwise direction D_{L} of the vehicle body structure 10. Opposite ends of each roof rail 22 are attached to side rail sections 30 defined along upper sides 32 the side assemblies 14 of the vehicle body structure 10. Further each of the side rail sections 30 extend in the vehicle lengthwise direction D_{L}. The roof panel 24 is attached to the roof bows 22 and the side rail sections 30 by, for example, welding techniques. The roof panel 24 is similarly attached to the rear beam 20.

As indicated in FIG. 2, the rear beam 20 has an overall width W₁ and each of the roof bows 22 has an overall width W₂, as measured in the vehicle lengthwise direction D_{L}. The width W₁ is greater than the width W₂. More specifically, the width W₁ is at least five (5) times the size of the width W₂.

There are two side assemblies 14, one on each lateral side of the vehicle body structure 10. The side assemblies 14 define A-pillars 32, B-pillars 34, C-pillars 36 and rear pillars 38. Further description of the side assemblies 14 is provided below.

The rear pillars 38 are structures of the vehicle body structure 10 that are part of the side assemblies 14 and are also part of the rear assembly 16. Further, it should be understood from the drawings and the description herein that the rear beam 20 is part of each of the roof assembly 12, the rear assembly 16 and the rear pillars 38.

As is clear by comparing FIGS. 1 and 2, the roof panel 24 at least partially conceals the rear beam 20 (as shown in FIG. 1). The rear beam 20 is visible in FIG. 2 with the roof panel 24 separated from the vehicle body structure 10 prior to installation.

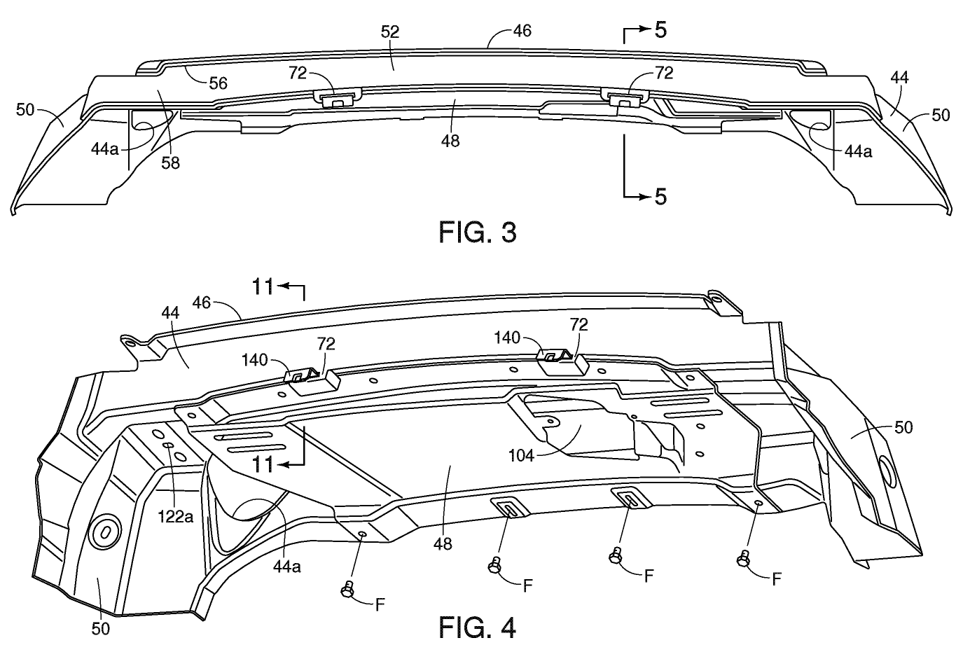

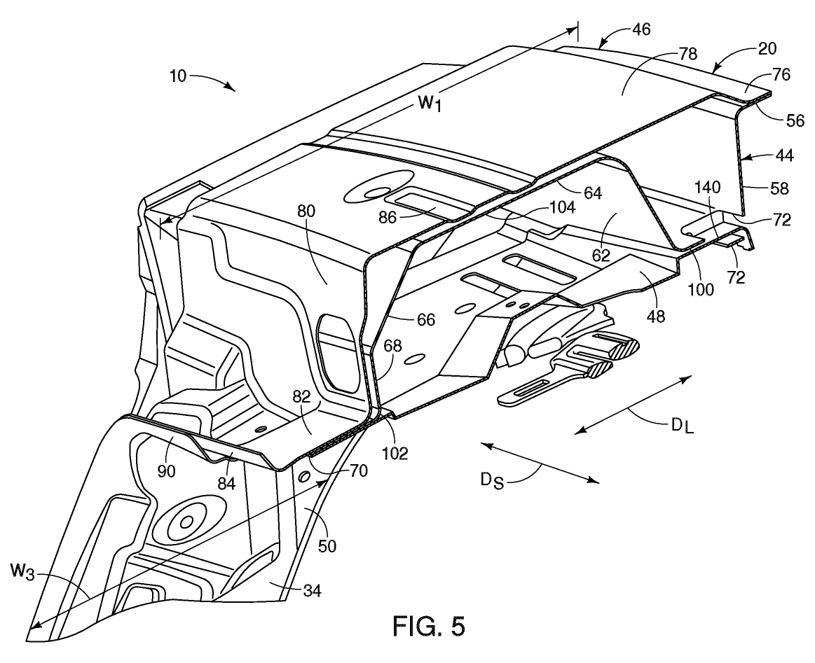

As shown in a front view (FIG. 3), a perspective front view (FIG. 4) and a cross-sectional view (FIG. 5), the rear beam 20 includes at least three panels, a main panel 44, an upper panel 46 and a removable accessory panel 48 (referred to hereinafter as the accessory panel 48). When in the closed orientation, the removable accessory panel 48 is held in place by the hinge portion 72 and 140 and mechanical fasteners F₁, as described below.

The main panel 44 (also referred to as the lower pane 44) extends the entire width of the roof assembly 12 (in the vehicle lateral direction D_{S}) and further includes two downwardly inclined side sections 50 that define upper portions of the rear pillars 38. Although the inclined side sections 50 extend downward relative to the vehicle body structure 10, they flare in outboard directions, as shown in FIG. 3 and hence, are not perpendicular to horizontal. A panel or panels that define a lower portion of the rear pillars 38 are welded to the inclined sections 50, as is described in greater detail below. The side sections 50 are also referred to herein below as first and second portions of the rear beam 20.

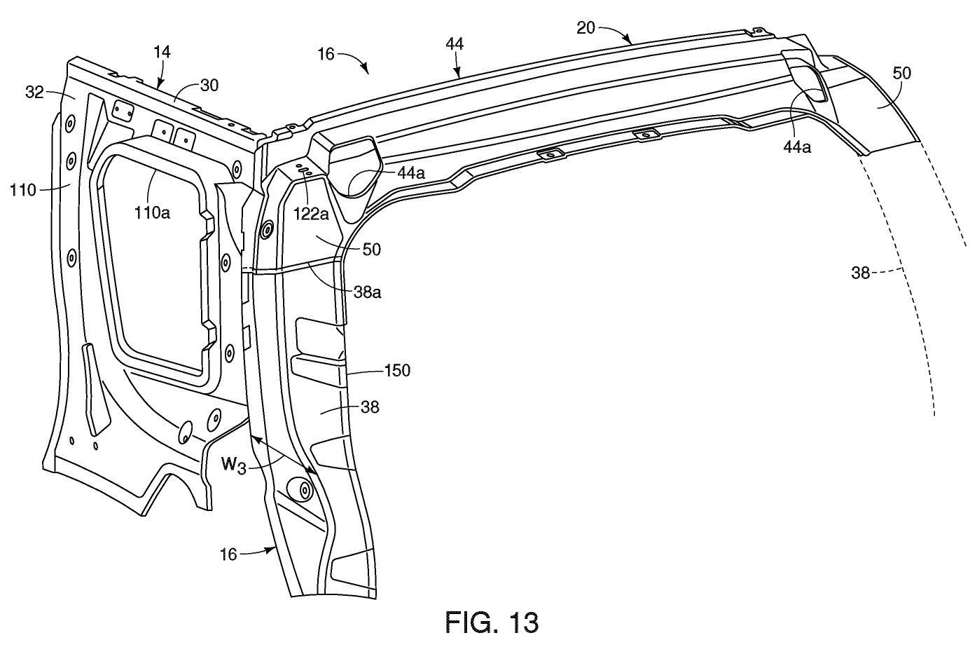

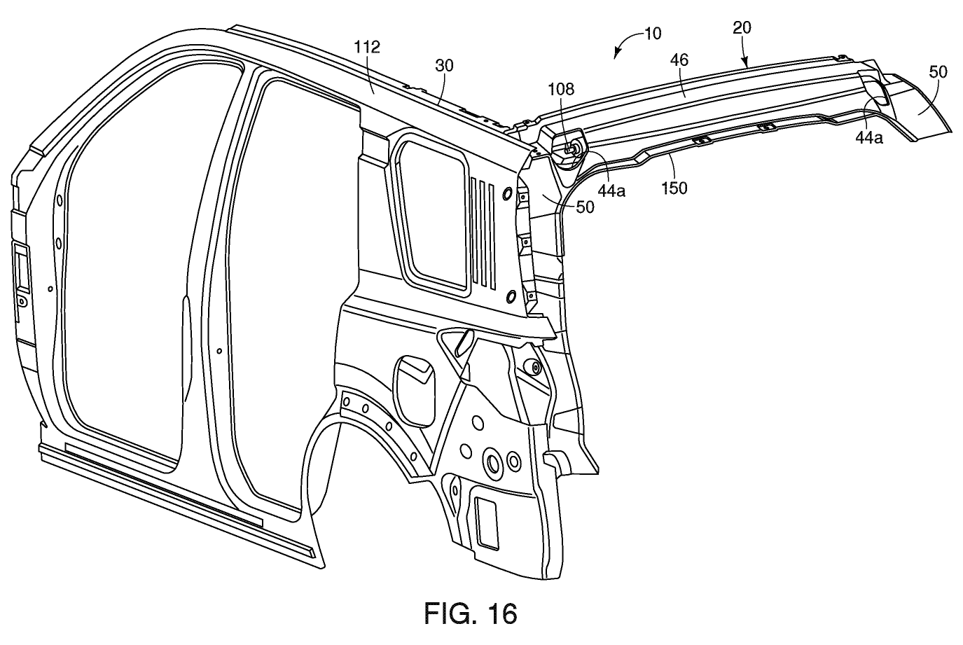

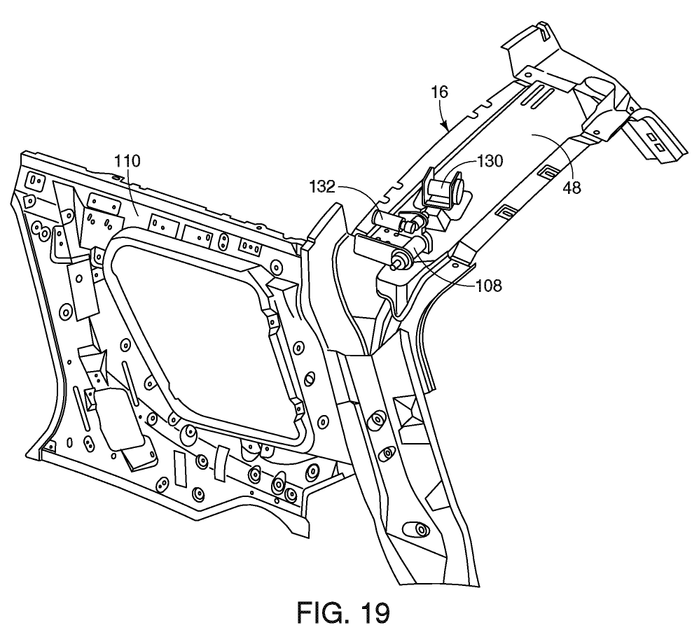

The main panel 44 also includes a central area 52 that extends between the inclined side sections 50. The central area 52 of the main panel 44 is also referred to herein below as the main portion of the rear beam 20. The central area 52 and the inclined side sections 50 are formed as a single, unitary, monolithic part. As shown in FIG. 13, the inclined sections 50 of the main panel 44 extend below the upper edge of a rear side window opening 110a in an inner side panel 110. In addition, main panel 44 has a pair of side openings 44a. The concave area 104 includes a pair of rear hatch door motors 108 (see FIGS. 16 and 19) that extend through side openings 44a to drive the rear hatch from the closed position to the open position.

As shown in FIG. 5, the central area 52 is shaped to include (from front to rear) a forward flange 56, a downwardly extending section 58, a rearwardly extending section 60, an upwardly inclined section 62, a flat main section 64, an downwardly inclined section 66, a rear upright section 68 and a rearwardly extending flange 70. The rearwardly extending section 60 includes two pairs of slots 72 (only one pair of slots 72 are visible in FIG. 5). Each pair of the slots 72 is also referred to as a first hinge portion 72, as described in greater detail below.

The forward flange 56, the downwardly extending section 58, the rearwardly extending section 60, the upwardly inclined section 62, the flat main section 64, an downwardly inclined section 66, the rear upright section 68 and the rearwardly extending flange 70 all extend generally parallel to the vehicle lateral direction D_{S} (side to side direction) and perpendicular to the vehicle lengthwise direction D_{L}.

The upper panel 46 includes an upper forward flange 76, a generally flat main section 78, a downwardly extending rear section 80, a first rear flange section 82 and a second rear flange section 84.

The upper forward flange 76 of the upper panel 46 is welded or otherwise rigidly fixed to the forward flange 56 of the main panel 44. The generally flat main section 78 includes a stiffening rib or concaved area 86. The first rear flange section 82 is welded to the rearwardly extending flange 70 of the central area 52. The second rear flange section 84 is welded to a flange 90 of the inclined side section 50 of the main panel 34.

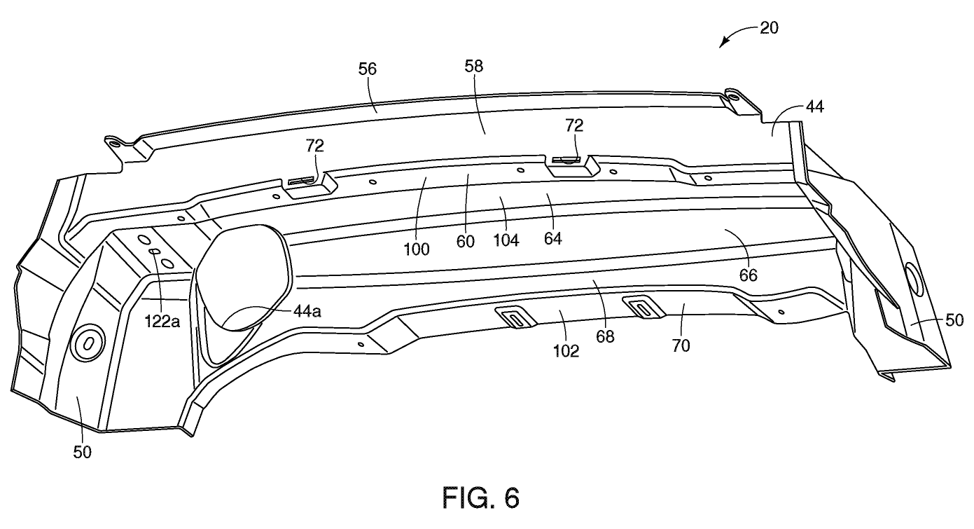

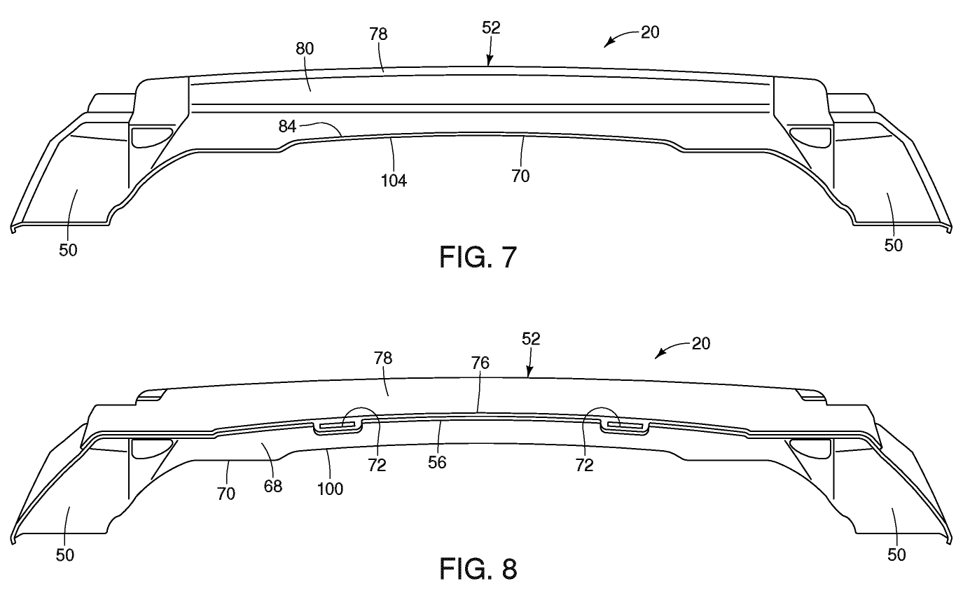

As shown in FIG. 5 with the accessory panel 48 installed and in FIG. 6 with the accessory panel 48 removed, with the main panel 44 and the upper panel 46 welded to one another, the rear beam 20 defines a first downwardly projecting ridge 100, a second downwardly projecting ridge 102 and a concaved area 104. The concaved area 104 extends between the first downwardly projecting ridge 100 and the projecting ridge 102, as viewed in FIG. 5 (ignoring the removable accessory panel 48). Further, the first downwardly projecting ridge 100, the second downwardly projecting ridge 102 and the concaved area 104 all extend in the vehicle lateral direction D_{S}. In other words, the first downwardly projecting ridge 100, the second downwardly projecting ridge 102 and the concaved area 104 extend in directions that are perpendicular to a vehicle lengthwise direction D_{L}. As well, the second downwardly projecting ridge 102 is generally parallel to the first downwardly projecting ridge 100 thereby defining the concaved area 104 therebetween.

It should be understood from the drawings and the description herein, that the first downwardly projecting ridge 100 is at least partially defined along the lower surface of the rearwardly extending section 60. As well, the second downwardly projecting ridge 102 is at least partially defined along the lower surface of the flat main section 64 and the concaved area 104 is at least partially defined along the lower surface of the rearwardly extending flange 70 of the main panel 44 of the rear beam 20.

Put another way, the first downwardly projecting ridge 100, the second downwardly projecting ridge 102 and the concaved area 104 define a U-shaped section of the rear beam 20. It should be understood that the U-shaped section is an inverted U-shape or upside down U-shape. As described in greater detail below, the concaved area 104 is dimensioned to receive at least one device that is attached to the vehicle body structure 10.

As mentioned above, the inclined side sections 50 of the rear beam 20 define and upper area of the rear pillars 38. At least an outer panel of each of the rear pillars 38 includes an overlapping flange 38a, as shown in FIG. 13. The overlapping flanges 38a extend above a bottom end of a corresponding one of the inclined side section 50 for purposes of welding the outer panels of the rear pillars 38 to the inclined side section 50 of the rear beam 20. Once the rear pillars 38 (aka first and second pillars 38) are assembled, they have a width W₃ measure in the vehicle lengthwise direction D_{L} and can be equal to the first width W₁ of the rear beam 20 or can be less than the first width W₁ of the rear beam 20. The width W₃ is shown in FIGS. 5 and 13. For example, rear pillars 38 can be dimensioned such that the width W₃ is any value between 75% and 100 % the value of the first width W₁ of the rear beam 20.

There are two side assemblies 14, one on opposite lateral sides of the vehicle body structure 10, as shown in FIGS. 1 and 2. Since the two side assemblies 14 are basically identical (except that they are symmetrical mirror images of one another), only one of the side assemblies 14 is described herein below but applies equally to both side assemblies 14, for the sake of brevity.

As shown in FIGS. 13-15, the side assembly 14 includes an inner side panel 110 that is welded to at least the rear pillar 38, the rear beam 20 and the roof panel 24. The upper end of the inner side panel 110 also defines at least a portion of the side rail sections 30 that are attached to the roof panel 24. As shown in FIG. 16, the side assembly 14 further includes an outer side panel 112 that is welded to at least areas of the inner side panel 110, the rear pillar 38, the rear beam 20 and the roof panel 24. The upper end of the outer side panel 112 also defines at least a portion of the side rail sections 30 that are attached to the roof panel 24.

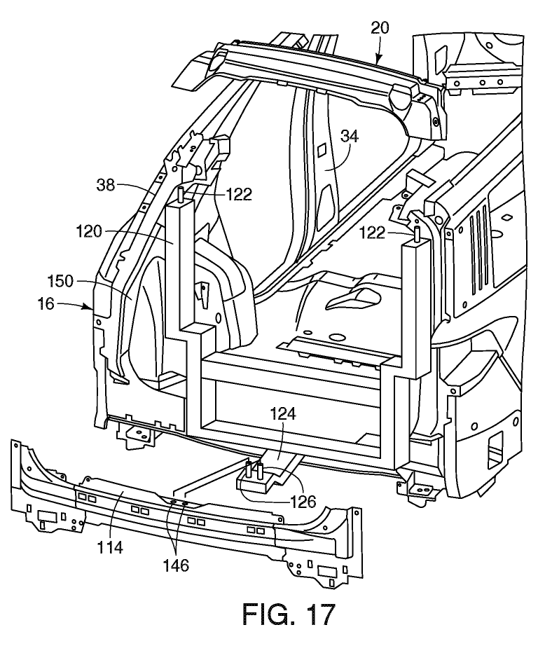

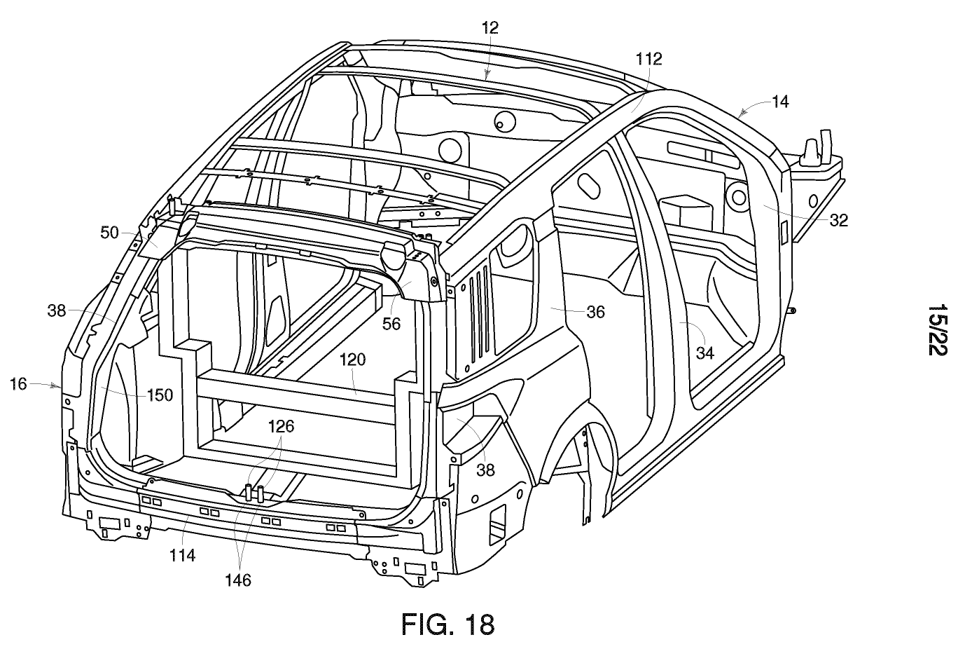

As shown in FIGS. 17 and 18, the rear assembly 16 includes at least the rear beam 20, the rear pillars 38 and a bottom panel 114.

The assembly process of the vehicle body structure 10 include fitting a plurality of panels together using various combinations of steps.

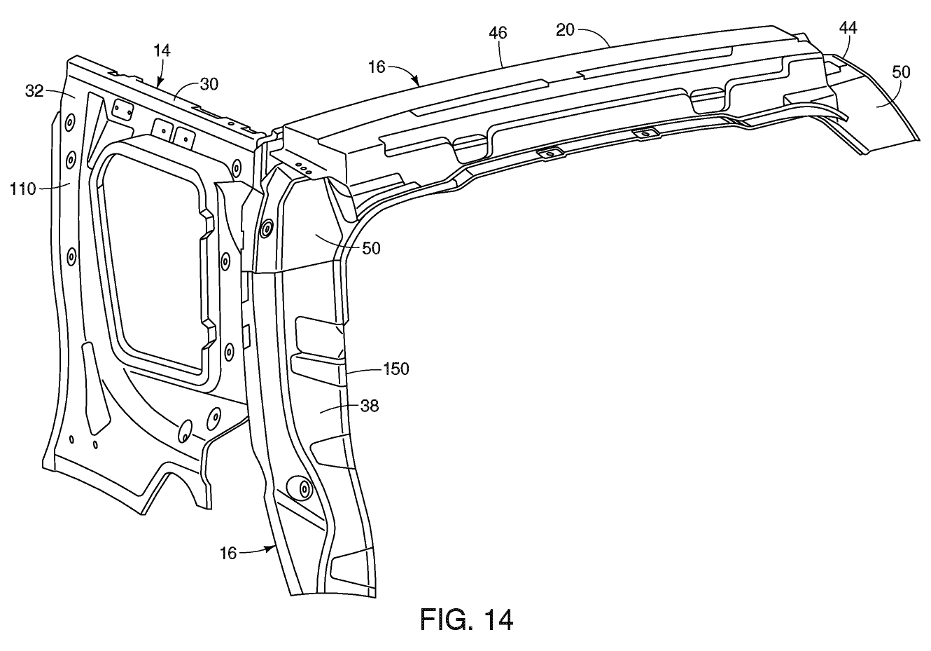

As shown in FIG. 13, inclined side section 50 of the main panel 44 of the rear beam 20 is welded to the overlapping portion 38a of the rear pillar 38. Thereafter, the inner side panel 110 can be welded to the rear pillar 38 and the main panel 44 of the rear beam 20, as shown in FIGS. 13 and 14. Thereafter, the upper panel 46 can be welded to the main panel 44 of the rear beam 20.

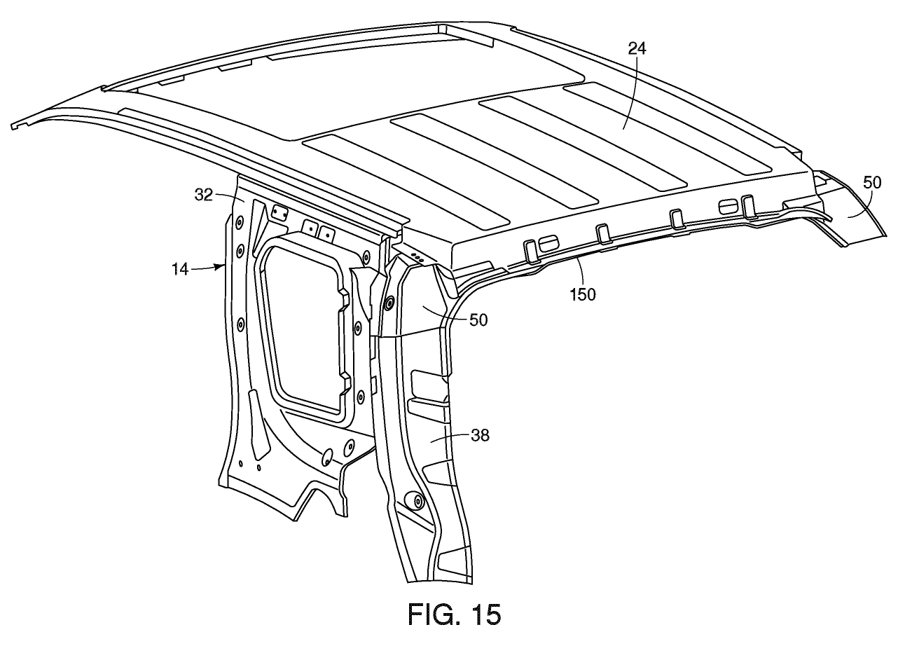

As shown in FIG. 16, the outer side panel 112 can be welded to the inner side panel 110, the rear beam 20 and the rear pillar 38. As shown in FIG. 15, the roof panel 24 can be welded to the rear pillar 38 and the inner side panel 110 (and later to the outer side panel 112). Alternatively, as shown in FIG. 2, the roof panel 24 can be welded to the rear pillar 38, the inner side panel 110 and the outer side panel 112. In other words, the sequence of assembling the various panels of the vehicle body structure 10 can vary depending upon the overall design and connections between the various elements.

As shown in FIGS. 17 and 18, during the assembly process of the vehicle body structure 10, the bottom panel 114 is welded to the bottom ends of the rear pillars 38. When the bottom panel 114 is fitted to the rear assembly 16 prior to welding, a jig 120 is useful in ensuring proper orientation of the bottom panel 114, the rear pillars 38 and the rear beam 20. During the fitting process, some or all of the panels, such as the inner side panel 110, the outer side panel 112, the panels of the rear pillar 38 and the bottom panel 114 can be left loose such that the accurate dimensions and structure of the jig 120 can ensure relatively precise orientation and alignment of the inner side panel 110, the outer side panel 112, the panels of the rear pillar 38, the rear beam 20 and the bottom panel 114 can be established prior to final welding of the inner side panel 110, the outer side panel 112, the panels of the rear pillar 38, the rear beam 20 and the bottom panel 114 to one another. Thereafter, the jig 120 is removed from the vehicle body structure 10.

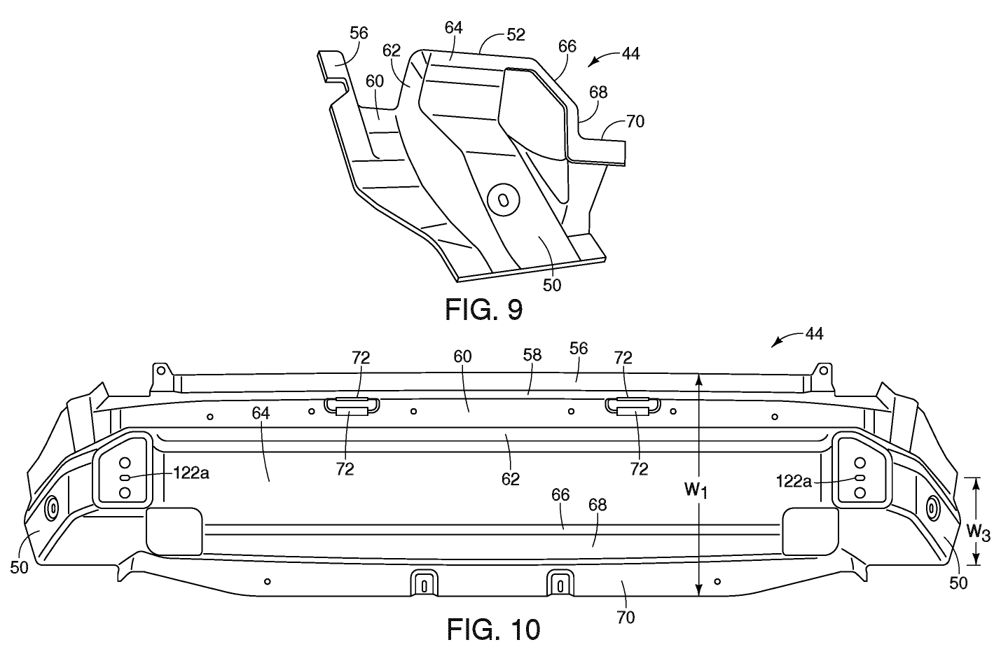

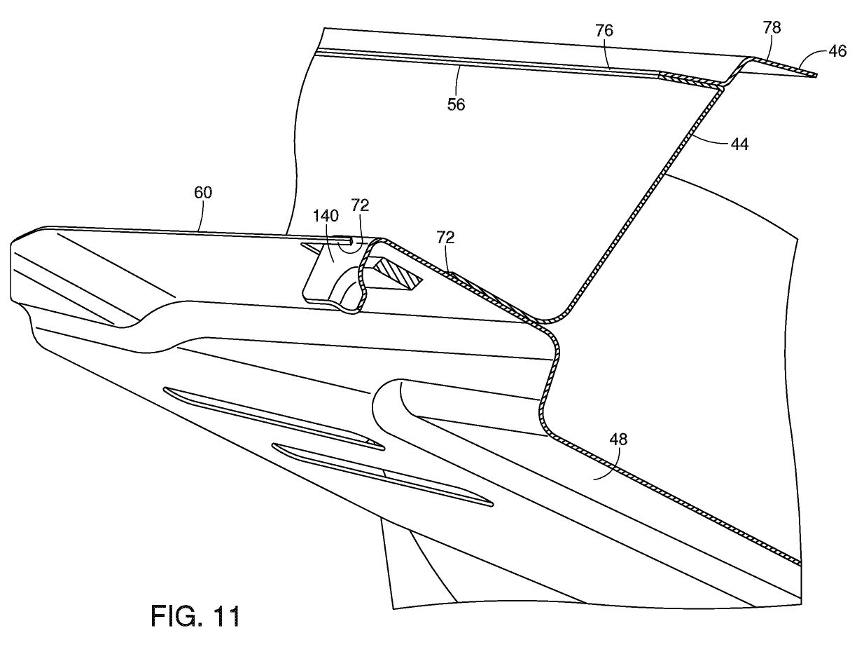

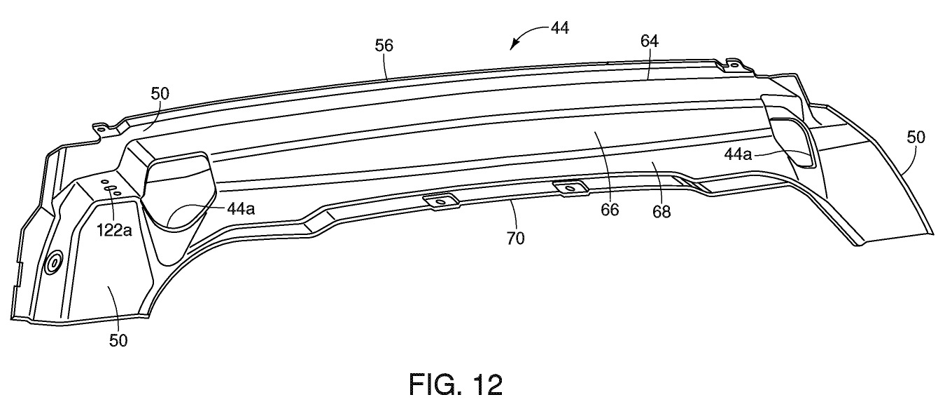

As shown in FIGS. 17 and 18, the jig 120 includes upper alignment pins 122 that are inserted into openings 122a in the rear beam 20 (see FIGS. 4, 6, 9-10 and 13). The jig 120 further includes a lower jig extension 124 (FIGS. 17-18) with lower alignment pins 126. The bottom panel 114 includes a pair of alignment openings 146 that are precisely positioned during the manufacture of the bottom panel 124 for use with the jig 120. The lower alignment pins 126 are inserted into the alignment openings 146 when the rear assembly 16 is being assembled. Similarly, when the rear beam 20 is manufactured, the openings 122a are precisely position for use with the jig 120.

Once the rear assembly 16 is fully assembled with pins 122 in the openings 122a and the alignment pins 126 in the openings 146, the various panels and rear beam 20 are properly oriented relative to one another due to the precise manufacturing of the jig 120. Once properly aligned with one another, the panels and rear beam 20 can be welded together. Use of the jig 120 assures that various panels and rear beam 20 of the rear assembly 16 are reliably oriented and aligned with one another thereby defining a rear hatch opening 150. A rear hatch door (not shown) can be more reliable fitted to the rear assembly 16 assuring proper opening and closing of the rear hatch door (not shown) after manufacturing of the vehicle body structure 10.

It should be understood from the drawings and the description herein that the rear hatch opening 150 is defined between the pillars 38, below the rear beam 20 and above the bottom panel 114.

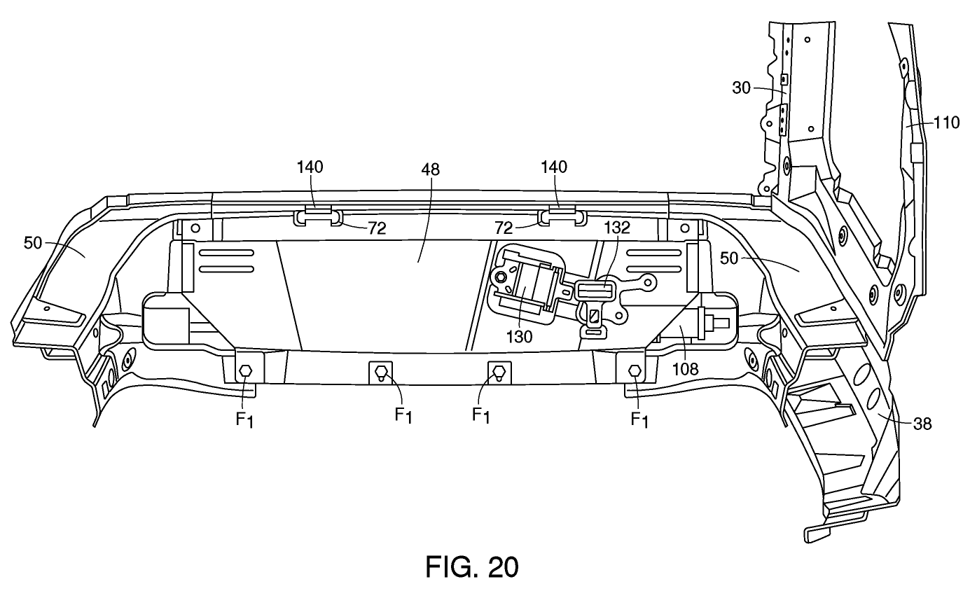

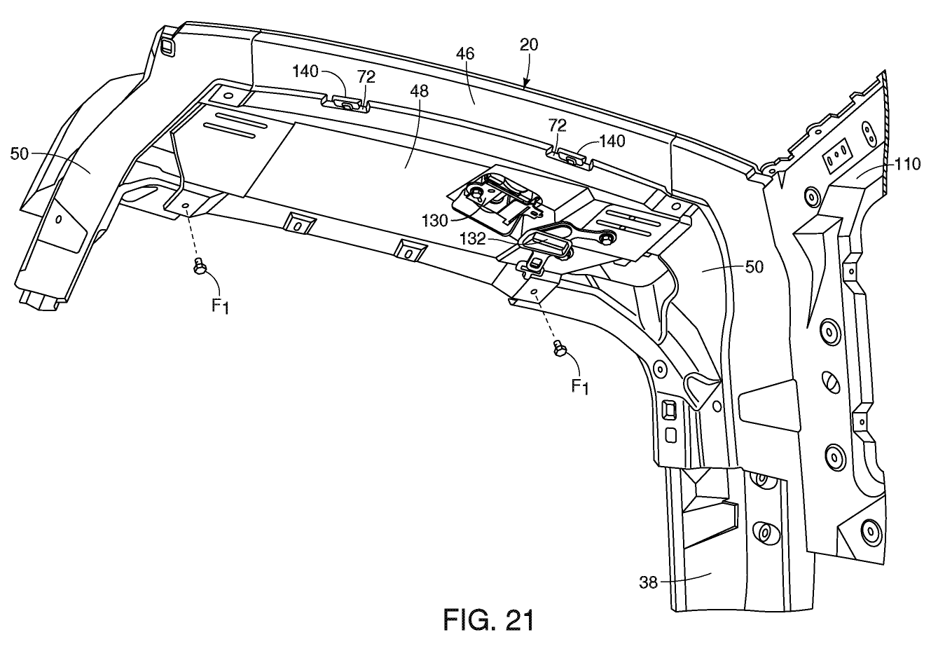

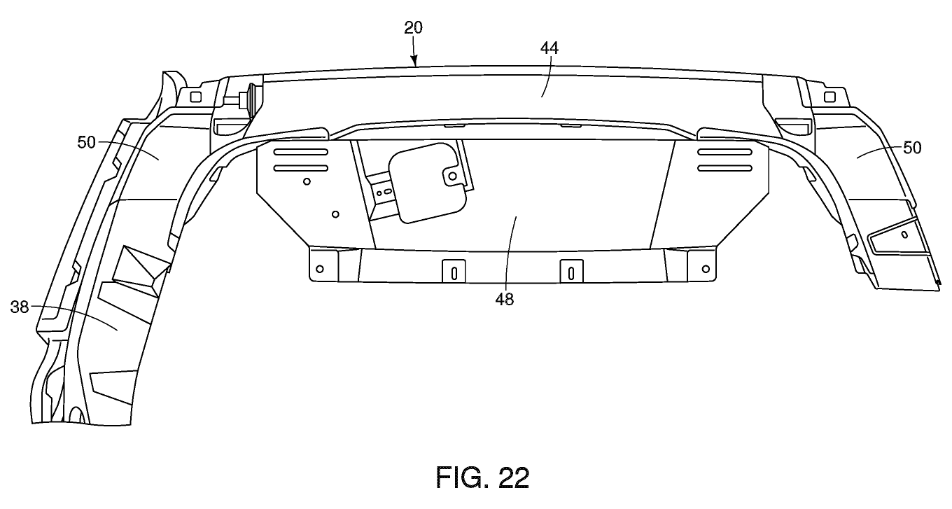

As shown in FIGS. 19-21, a motor 108, a seatbelt device 130 and a seatbelt guide 132 (also referred to as a seatbelt D-ring 132) are installed to the rear beam 20 within the concaved area 104. The removable accessory panel 48 (also referred to as the accessory panel 48) can be pivoted downward, as shown in FIG. 22, exposing the concaved area 104. In a closed orientation, the accessory panel 48 covers and partially conceals the concaved area 104 along the underside of the rear beam 20. As shown in FIG. 16, a shaft of the motor 108 extends out of the opening 44a and a portion of the motor 108 itself is visible through the opening 44a. The motor 108 is provided to electrically move a rear hatch cover (not shown) between a closed orientation covering the rear hatch opening 150 and an open orientation exposing the rear hatch opening 150 in a conventional manner.

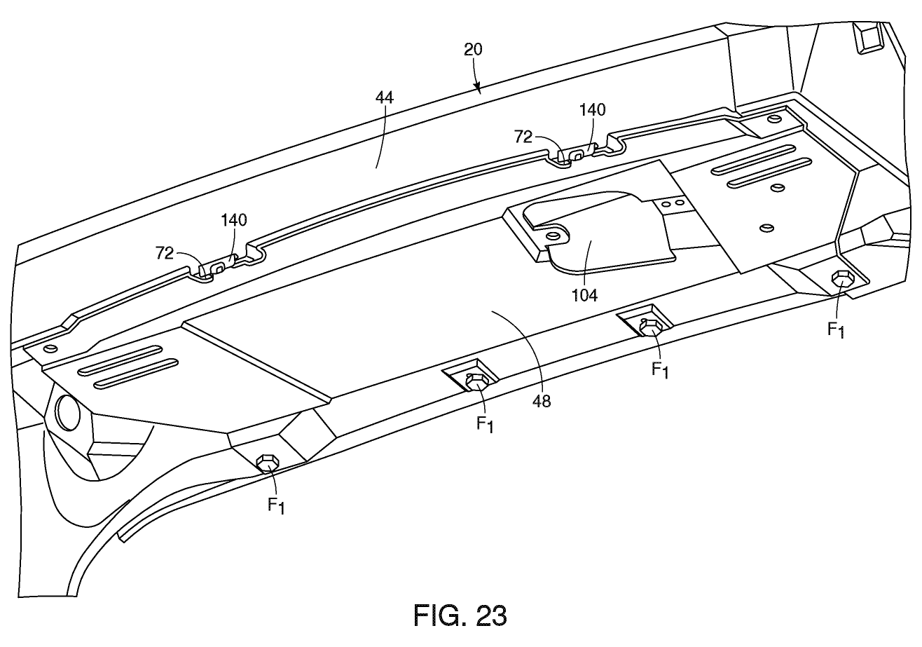

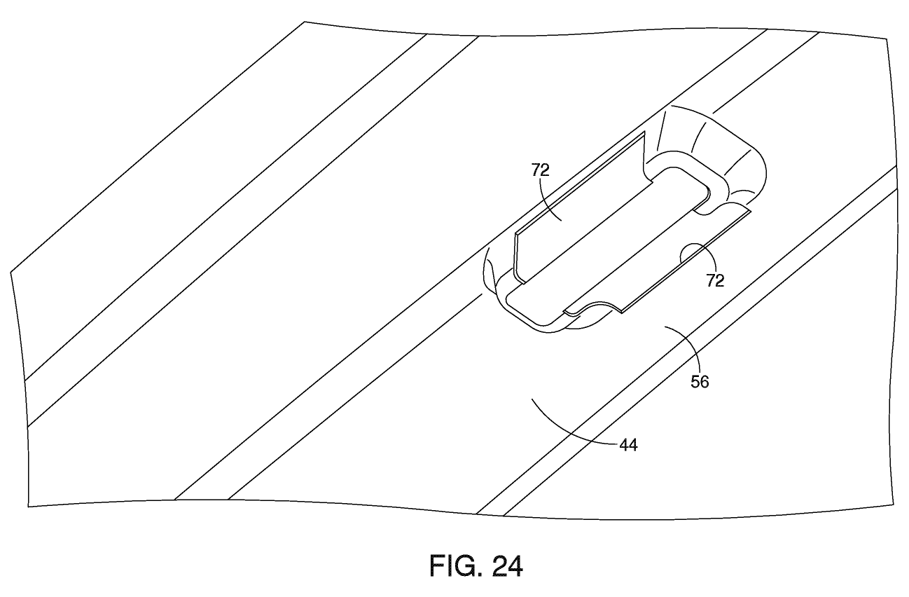

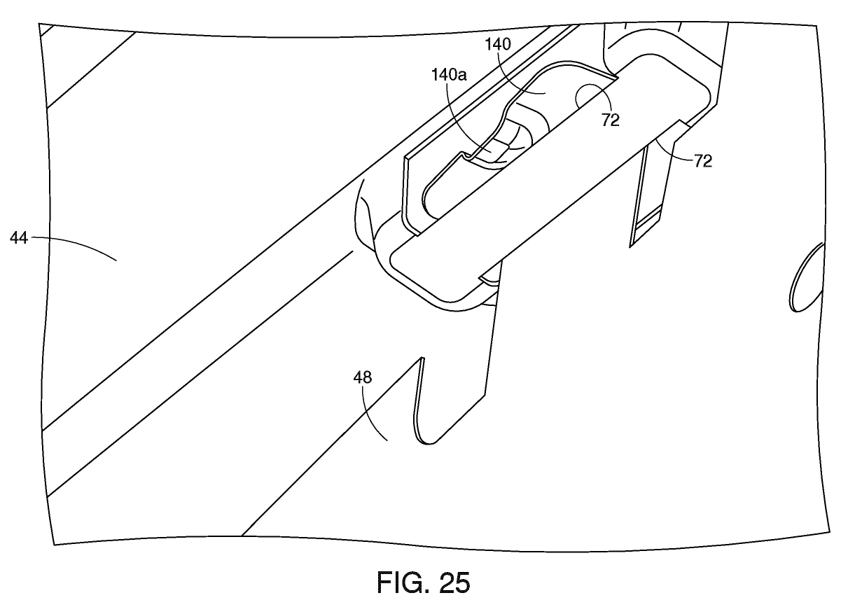

As shown in FIGS. 5 and 23, the accessory panel 48 includes two hinge extensions 140 that are spaced apart from one another. Each of the hinge extensions 140 is inserted through corresponding pairs of the slots 72. The slots 72 define a first hinge portion and the hinge extensions 140 define a second hinge portion. The hinge extensions 140 and the pairs of slots 72 define a pair of spaced apart hinges about which the accessory panel 48 can pivot. The accessory panel 48 can be moved between an open orientation shown in FIG. 22 and a closed orientation shown in FIG. 23. As shown in FIG. 25, each of the hinge extensions 140 includes a projection 140a at a distal end thereof that contacts a corresponding edge of a corresponding slot 72 when in the open orientation, preventing the hinge extension 140 from slipping out of the slots 72 with the accessory panel 48 in the open orientation.

With the accessory panel 38 in the open orientation (also referred to as the open position) the concaved area 104 is exposed and in the closed orientation (also referred to as the closed position) the concaved area 104 is at least partially concealed by the accessory panel 48.

The various elements of the vehicle body structure (except the roof assembly 12, the side frame assemblies 14, the rear assembly 16 and the rear beam 20), are conventional components that are well known in the art. Since these structural elements are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the vehicle body structure. Accordingly, these terms, as utilized to describe the present invention should be interpreted relative to a vehicle equipped with the vehicle body structure.

The term “configured” as used herein to describe a component, section or part of a device includes structure that is designed and constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle body structure, comprising:
a vehicle roof structure that includes a rear roof bow adjacent to a rear hatch door opening, the rear roof bow having a concaved area with a first hinge portion located adjacent to the concaved area; and
an accessory panel having a second hinge portion that couples to the first hinge portion such that the accessory panel is pivotal between an open position and a stowed position, wherein
in the open position the concaved area is exposed and in the closed position the concaved area is at least partially concealed.

2. The vehicle body structure according to claim 1, wherein
the rear roof bow includes a downwardly projecting ridge that extends in a vehicle lateral direction adjacent to the concaved area, the downwardly projecting ridge defining the first hinge portion.

3. The vehicle body structure according to claim 2, wherein
the first hinge portion includes a pair of slots spaced apart from one another by a first distance, the slots being defined along the downwardly projecting ridge.

4. The vehicle body structure according to claim 3, wherein
the second hinge portion includes a pair of non-planar projections spaced apart from one another by the first distance extending from one end of the accessory panel such that the non-planar projections are inserted into corresponding ones of the pair of slots.

5. The vehicle body structure according to claim 1, wherein
the first hinge portion includes a pair of slots spaced apart from one another by a first distance.

6. The vehicle body structure according to claim 5, wherein
the second hinge portion includes a pair of non-planar projections spaced apart from one another by the first distance extending from one end of the accessory panel such that the non-planar projections are inserted into corresponding ones of the pair of slots.

7. The vehicle body structure according to claim 1, further comprising
at least one accessory device attached to the accessory panel such that the at least one accessory device is accessible with the accessory panel in the open position and is at least partially concealed within the concaved area with the accessory panel in the closed position.

8. The vehicle body structure according to claim 7, wherein
the at least one accessory device includes a seatbelt retraction device.

9. The vehicle body structure according to claim 8, wherein
the at least one accessory device includes a seatbelt D-ring.

10. The vehicle body structure according to claim 1, further comprising
at least one accessory device attached to the rear roof bow that is accessible with the accessory panel in the open position and is at least partially concealed with the accessory panel in the closed position.

11. The vehicle body structure according to claim 10, further comprising
the at least one accessory device is an electric motor connected to a rear door hinge structure, the electric motor being operable to move a rear door from an open orientation exposing the rear hatch door opening and a closed orientation covering the rear hatch door opening.
